(19) United States
(12) Patent Application Publication
(10) Pub. No.: US 2013/0001375 A1
(43) Pub. Date: Jan. 3, 2013

(54) CABLE TIE ASSEMBLY

(75) Inventors: CHAO GENG, Wuhan City (CN); QIU-HUA BIN, Wuhan City (CN); ZHI-GUO ZHANG, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/426,713

(22) Filed: Mar. 22, 2012

(30) Foreign Application Priority Data
Jun. 29, 2011 (CN) 201110179294.5

(51) Int. Cl. F16L 3/12

(52) U.S. Cl. 248/74.3

(57) ABSTRACT

A cable tie includes a tie portion. The tie portion includes two tie parts. Each tie part is S-shaped. Each tie part includes a bent portion, an engaging portion extending from the bent portion, and a stopper protrusion extending from the engaging portion. The two bent portions are connected to each other and is U-shaped. The two bent portions are capable of moving towards each other to enable the two engaging portions to engage each other. Each stopper protrusion is in the shape of a truncated pyramid. Each stopper protrusion includes a first bottom surface and a second bottom surface substantially parallel to the first bottom surface. An area of the second bottom surface is less than an area of the first bottom surface.

### BACKGROUND

1. Technical Field

The disclosure relates to cable tie assemblies.

2. Description of Related Art

There are many cables or wires used in computers for power output and data transmission. These cables are secured by a plurality of securing portions directly extending from the enclosure of the computer. Plastic surfaces of these cables may be damaged if the securing portions are applied too tightly.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a cable tie assembly of an embodiment.

FIG. 2 is an isometric view of a cable tie of FIG. 1.

FIG. 3 is a section view of the cable tie of FIG. 2.

FIG. 4 is an assembly view of FIG. 1.

FIG. 5 is a partial enlarged view of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

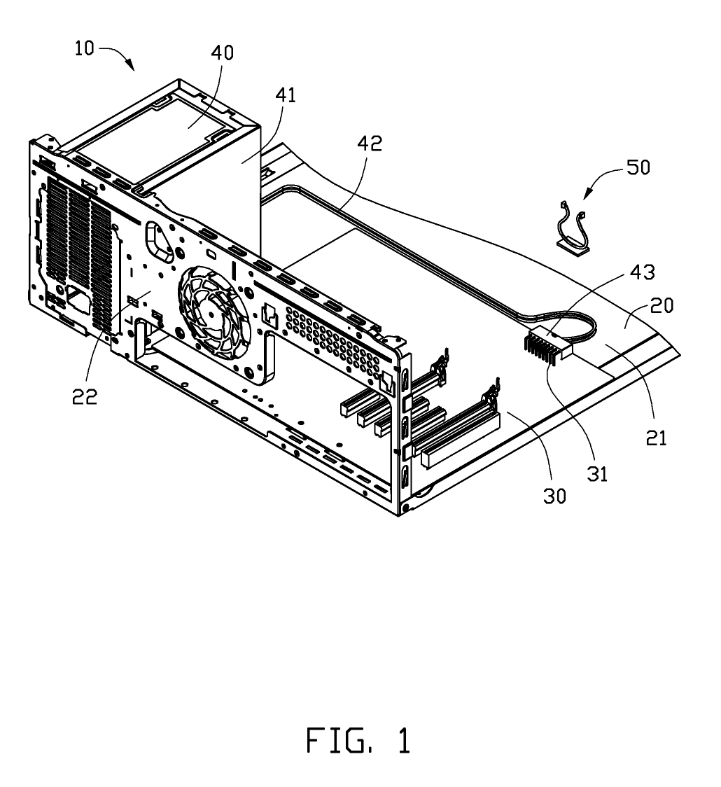

Referring to FIG. 1, A cable tie assembly includes a device 10 and a cable tie 50. The device 10 includes an enclosure 20, a printed circuit board (PCB) 30, and a power supply 40. The enclosure 20 includes a bottom panel 21 and rear panel 22 extending perpendicularly from the bottom panel 21. The power supply 40 is mounted to the rear panel 22. The power supply 40 includes a main body 41, a plurality of connecting cables 42 connected to the main body 41, and a connector 43 connected to the connecting cables 42.

The PCB 30 is mounted to the bottom panel 21. The PCB 30 is substantially parallel to the bottom panel 21. The PCB 30 includes a terminal 31 for connecting to the connector 43.

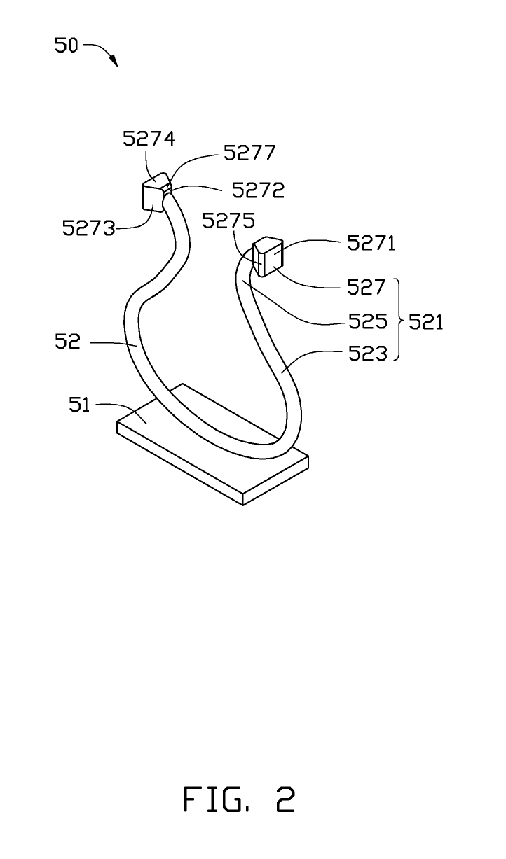

Referring to FIG. 2, the cable tie 50 includes a base 51 and a tie portion 52 extending from the base 51. The tie portion 52 includes two tie parts 521 connected to each other. Each tie part 521 includes a bent portion 523, an engaging portion 525, and a stopper protrusion 527. Each tie part 521 is S-shaped. The two bent portions 523 are connected to each other and are U-shaped. The bent portion 523 bends in either the clockwise direction or the anti-clockwise direction. The engaging portion 525 bends in the opposite direction relative to the extending direction of the bent portion 525. The stopper protrusion 527 is in the shape of a four-sided truncated pyramid. The stopper protrusion 527 includes a first bottom surface 5271 and a second bottom surface 5272 substantially parallel to the first bottom surface 5271. The second bottom surface 5272 is connected to the engaging portion 525. An area of the second bottom surface 5272 is less than an area of the first bottom surface 5271. The stopper protrusion 527 further includes two first side surfaces 5273 and two second side surfaces 5274 connected between the first bottom surface 5271 and the second bottom surface 5272. Each first side surface 5273 is connected to the first bottom surface 5271 via a first bent surface 5275. Each second side surface 5274 is connected to the second bottom surface 5272 via a second bent surface 5277. The first bent surface 5275 and the second bent surface 5277 are both arc-shaped.

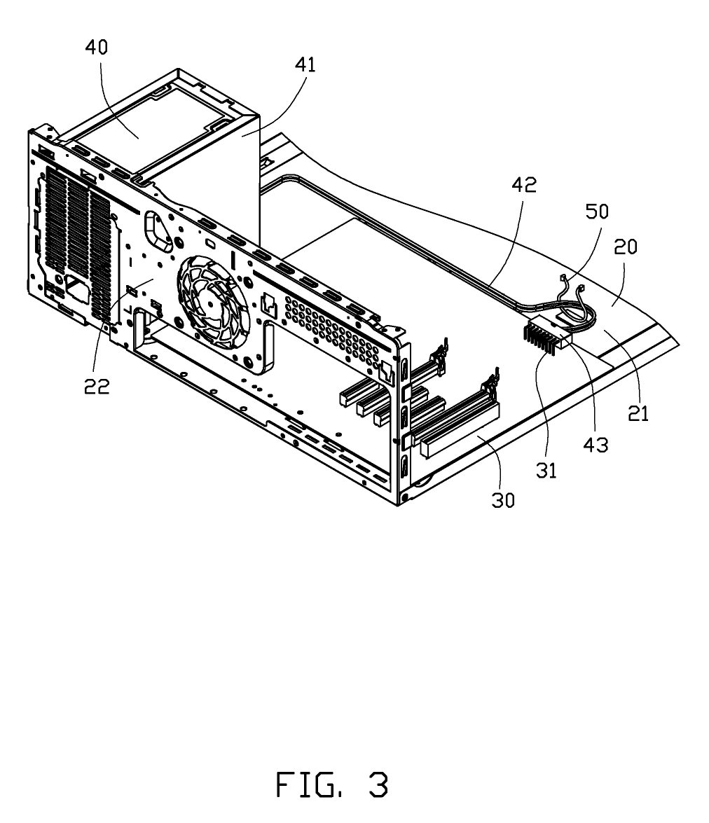

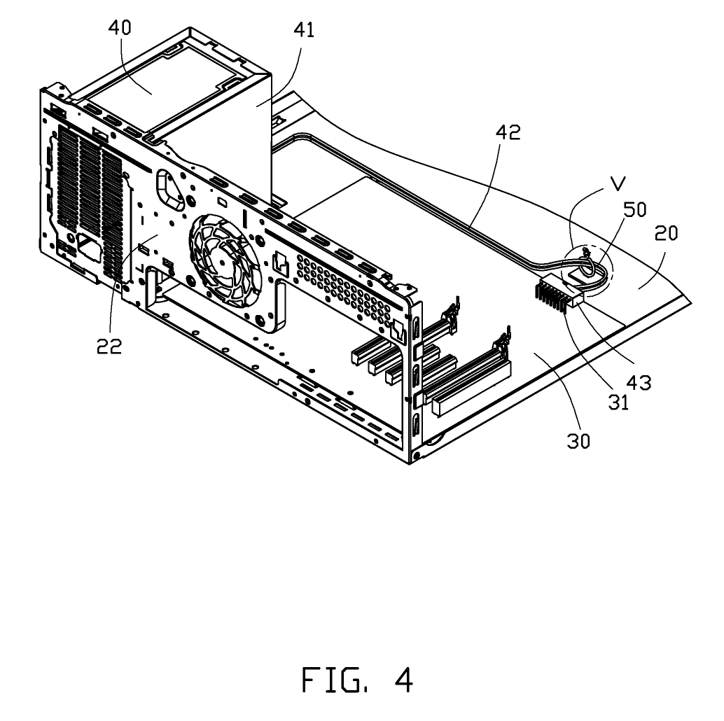

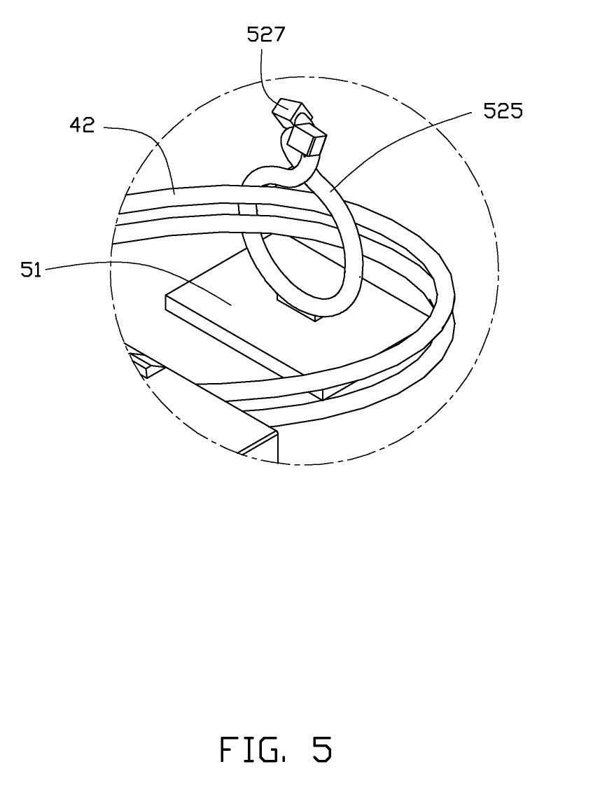

Referring to FIGS. 3 to 5, in assembly, the base 51 of the cable tie 50 is secured to the bottom panel 21 by soldering. At this time, the base 51 is substantially parallel to the bottom panel 21. The connector 43 of the power supply 40 is connected to the terminal 31 of the PCB 30. The connecting cables 42 are placed between the two tie parts 521. The bent portions 523 are pressed to be deformed towards each other. The engaging portions 525 are driven to move towards each other. During the process, one stopper protrusion 527 of one tie part 521 moves from one side of the other tie part 521 to the opposite side of the other tie part 521. The two bent portions 523 release gradually to enable the two engaging portions 525 to engage each other. Thereby the connecting cables 42 are secured in the cable tie 50.

In disassembly, the bent portions 523 are pressed to be deformed to move towards each other. The engaging portions 525 are driven to move away from each other to disengage from each other. Thus, the connecting cables 42 can be easily removed from the cable tie 50.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A cable tie, comprising:
a tie portion, the tie portion comprising two tie parts; each tie part is S-shaped; each tie part comprising a bent portion, an engaging portion extending from the bent portion, and a stopper protrusion extending from the engaging portion; the two bent portions are connected to each other and are U-shaped; the two bent portions capable of moving towards each other to enable the two engaging portions to engage each other; each stopper protrusion is truncated-pyramid shaped; each stopper protrusion comprising a first bottom surface and a second bottom surface that is substantially parallel to the first bottom surface; and an area of the second bottom surface is less than an area of the first bottom surface.

2. The cable tie of claim 1, wherein each stopper protrusion comprises a first side surface connected between the first bottom surface and the second bottom surface; and the first side surface is connected to the first bottom surface via a first bent surface.

3. The cable tie of claim 2, wherein each stopper protrusion comprises a second side surface connected between the first bottom surface and the second bottom surface; and the second side surface is connected to the second bottom surface via a second bent surface.

4. The cable tie of claim 3, wherein the first bent surface and the second bent surface are both arc-shaped.

5. The cable tie of claim 4, wherein each stopper protrusion is in a shape of a four-sided truncated pyramid.

6. The cable tie of claim 1, further comprising a base, wherein the base is connected to the two bent portions.

7. A cable tie assembly comprising:
an enclosure, the enclosure comprising a bottom panel; and
a cable tie, the cable tie comprising:
a base, the base mounted to the bottom panel and substantially parallel to the bottom panel; and
a tie portion, the tie portion comprising a U-shaped bent portion extending from the base and two engaging portions extending outward from two ends of the U-shaped bent portion; the two engaging portions capable of moving towards each other to engage each other.

8. The cable tie assembly of claim 7, wherein the tie portion further comprises a stopper protrusion extending from one of the two engaging portions, the stopper protrusion is truncated-pyramid shaped; the stopper protrusion comprises a first bottom surface and a second bottom surface substantially parallel to the first bottom surface; and an area of the second bottom surface is less than an area of the first bottom surface.

9. The cable tie assembly of claim 8, wherein the stopper protrusion comprises a first side surface connected between the first bottom surface and the second bottom surface; and the first side surface is connected to the first bottom surface via a first bent surface.

10. The cable tie assembly of claim 9, wherein the stopper protrusion comprises a second side surface connected between the first bottom surface and the second bottom surface; and the second side surface is connected to the second bottom surface via a second bent surface.

11. The cable tie assembly of claim 10, wherein the first bent surface and the second bent surface are both arc-shaped.

12. The cable tie assembly of claim 11, wherein the stopper protrusion is in a shape of a four-sided truncated pyramid.
